(19) United States
(12) Patent Application Publication
(10) Pub. No.: US 2013/0094374 A1
(43) Pub. Date: Apr. 18, 2013

(54) METHOD AND APPARATUS FOR VIRTUAL ADAPTIVE UPLINK ATTENUATION

(71) Applicants: Yan Zhou, San Diego, CA (US); Vinay Chande, San Diego, CA (US); Farhad Meshkati, San Diego, CA (US); Mehmet Yavuz, San Diego, CA (US)

(72) Inventors: Yan Zhou, San Diego, CA (US); Vinay Chande, San Diego, CA (US); Farhad Meshkati, San Diego, CA (US); Mehmet Yavuz, San Diego, CA (US)

(73) Assignee: QUALCOMM Incorporated, San Diego, CA (US)

(21) Appl. No.: 13/274,245

(22) Filed: Oct. 14, 2011

(51) Int. Cl. H04W 24/00; H04W 36/18

(52) U.S. Cl. 370/252

(57) ABSTRACT

Techniques are provided for overcoming uplink (UL) interference at a femtocell or the like by modifying the estimated interference-plus-noise power in UL power control. In one example, the modification can be specified by a method, operable by a network entity, that may involve determining a level of excess received interference based at least in part on out-of-cell interference (Ioc). In another example, the modification can be specified by a method, operable by a network entity, that may involve determining a difference between the downlink transmit powers of the high-speed downlink packet access (HSDPA) serving and non-serving cells, with which the UE are in soft handover (SHO) in uplink and is served by the HSDPA serving cell in downlink.

### BACKGROUND

I. Field

The present disclosure relates generally to communication systems, and more specifically to techniques for improving interference management.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of mobile entities, such as, for example, user equipments (UEs). A UE may communicate with a base station via the downlink (DL) and uplink (UL). The DL (or forward link) refers to the communication link from the base station to the UE, and the UL (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macro cellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, and small-coverage base stations (e.g., picocells and femtocells).

The Femto Forum, a non-profit membership organization focused on standardization and promotion of femtocell solutions, defines femto access points (FAPs), also referred to as femtocell units, to be low-powered wireless access points that operate in licensed spectrum and are controlled by the network operator, can be connected with existing handsets, and use a residential digital subscriber line (DSL) or cable connection for backhaul. In various standards or contexts, a FAP may be referred to as a home node B (HNB), home e-node B (HeNB), access point base station, etc.

Since radio frequency (RF) coverage of FAPs or the like may not be optimized by the mobile operator, and deployment of such base stations may be ad hoc, RF interference issues may arise. Moreover, soft handover (SHO) may not be supported for small-coverage base stations. Also a mobile station may not be allowed to communicate with the access point which has the best RF signal due to restricted association (i.e., closed subscriber group) requirement. Thus, there is a need for improved interference management for wireless networks that include FAPs or similar types of small-coverage base stations.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, a method is provided for Virtual Adaptive Uplink Attenuation (VAUA), wherein the method may be performed by a network entity, such as, for example, an evolved Node B (eNB). The method may involve determining a level of excess received interference based at least in part on out-of-cell interference (Ioc). The method may also involve determining a difference between the downlink transmit powers of the high-speed downlink packet access (HSDPA) serving and non-serving cells, with which the UE are in soft handover (SHO) in uplink and is served by the HSDPA serving cell in downlink. The method may further involve calculating, for a specific user equipment (UE), an additional path loss (PL) on an uplink (UL) signal, in response to the level of excess received interference exceeding an interference target that would cause a Rise-over-Thermal (RoT) metric to exceed conditions for stable system operation. The method may also involve increasing an estimated interference-plus-noise power by the calculated additional PL. In related aspects, an electronic device (e.g., an eNB or component(s) thereof) may be configured to execute the above-described methodology.

In accordance with one or more aspects of the embodiments described herein, there is provided a VAUA method that may be performed by a mobile entity, such as, for example, a UE. The method may involve receiving an additional PL value from a serving network entity, in response to a level of excess mobile received power at the serving network entity exceeding a received power target that would cause a RoT metric to exceed conditions for stable system operation. The method may further involve attenuating a transmit power of the mobile entity based at least in part on the received additional PL value. In related aspects, an electronic device (e.g., a UE or component(s) thereof) may be configured to execute the above-described methodology.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram conceptually illustrating an example of a telecommunications system.

FIG. 2 illustrates a planned or semi-planned wireless communication environment.

FIG. 3 is a simplified diagram of a specific arrangement of femto access points (FAPs) and user equipments (UEs) illustrating potentially negative geometries.

FIG. 4A is a simplified block diagram of several sample aspects of a communication system.

FIG. 4B is a flowchart of several sample aspects of operations that may be performed to manage interference.

FIG. 5 illustrates aspects of interference management components in a communication system.

FIG. 6 illustrates an example Virtual Adaptive Uplink Attenuation (VAUA) methodology executable by a network entity (e.g., an eNB).

FIGS. 7A-B illustrate further aspects of the methodology of FIG. 6.

FIG. 8 shows an embodiment of an apparatus for VAUA, in accordance with the methodology of FIGS. 6-7.

FIG. 9 illustrates an example VAUA methodology executable by a mobile entity (e.g., a UE).

FIG. 10 shows an embodiment of an apparatus for VAUA, in accordance with the methodology of FIG. 9.

### DETAILED DESCRIPTION

Techniques for interference management in a wireless communication system are described herein. The techniques may be used for various wireless communication networks such as wireless wide area networks (WWANs) and wireless local area networks (WLANs). The terms “network” and “system” are often used interchangeably. The WWANs may be CDMA, TDMA, FDMA, OFDMA, SC-FDMA and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink (DL) and SC-FDMA on the uplink (UL). UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

The techniques described herein may be used for the wireless networks and radio technologies mentioned above as well as other wireless networks and radio technologies. For clarity, certain aspects of the techniques are explained in the exemplary context of 3GPP networks, and more particularly in the context of the interference management for such networks. The word “exemplary” is used herein to mean “serving as an example, instance, or illustration.” Any embodiment described herein as “exemplary” is not necessarily to be construed as preferred or advantageous over other embodiments.

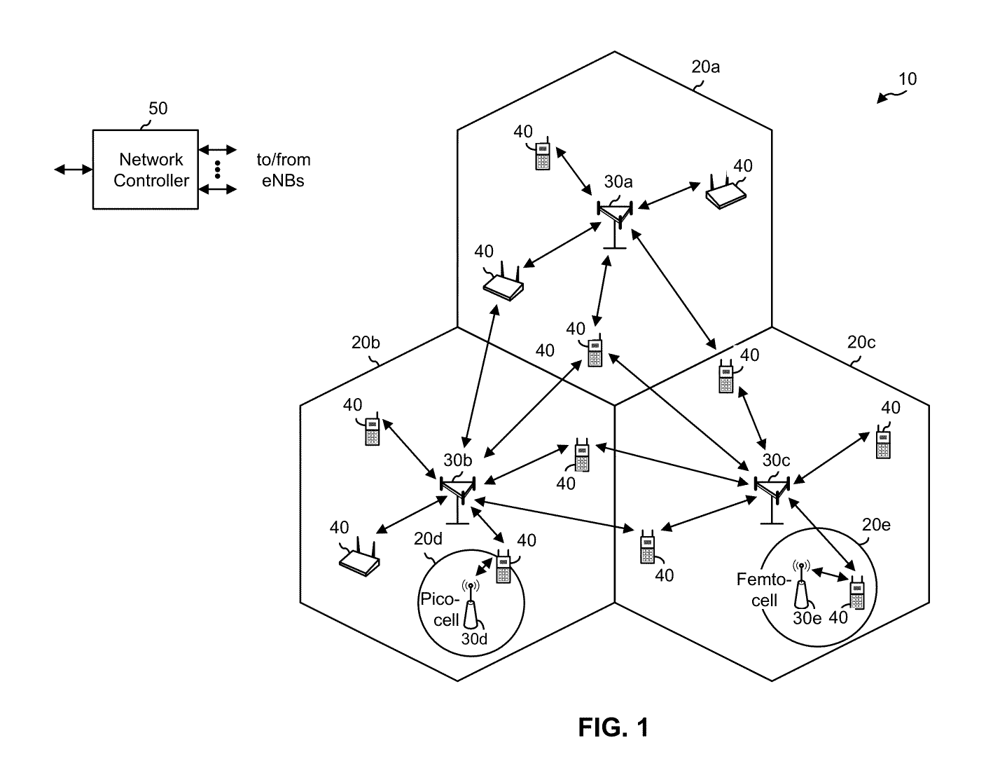

FIG. 1 shows a wireless communication network 10, which may be an LTE network or some other wireless network. Wireless network 10 may include a number of evolved Node Bs (eNBs) 30 and other network entities. An eNB may be an entity that communicates with mobile entities (e.g., user equipment (UE)) and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities (e.g., UEs) located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macro cell, a picocell, a femtocell, and/or other types of cell. A macro cell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having association with the femtocell (e.g., UEs in a Closed Subscriber Group (CSG)). In the example shown in FIG. 1, eNBs 30a, 30b, and 30c may be macro eNBs for macro cell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a femto eNB or femto access point (FAP) for a femtocell 20e.

Wireless network 10 may also include relays (not shown in FIG. 1). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may include a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, etc. A UE may also be able to communicate peer-to-peer (P2P) with other UEs.

Wireless network 10 may support operation on a single carrier or multiple carriers for each of the DL and UL. A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the given DL carrier.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), and/or multiple-input multiple-output (MIMO). For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

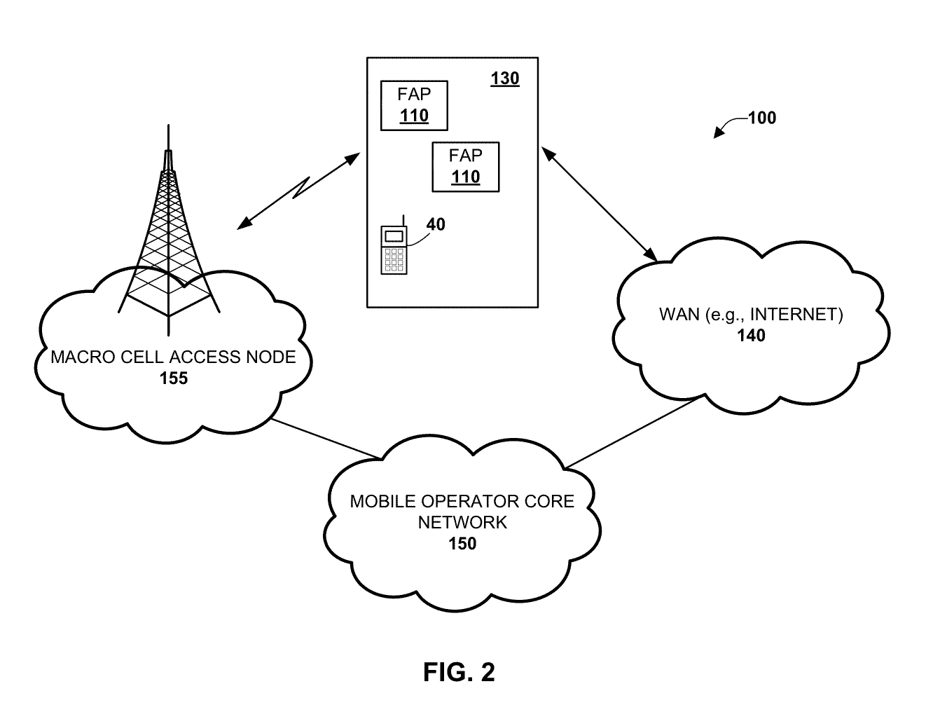

FIG. 2 is an illustration of a planned or semi-planned wireless communication environment 100, in accordance with various aspects. Communication environment 100 includes multiple access point base stations, including FAPs 110, each of which are installed in corresponding small scale network environments. Examples of small scale network environments can include user residences, places of business, indoor/outdoor facilities 130, and so forth. The FAPs 110 can be configured to serve associated UEs 40 (e.g., included in a CSG associated with FAPs 110), or optionally alien or visitor UEs 40 (e.g., UEs that are not configured for the CSG of the FAP 110). Each FAP 110 is further coupled to a wide area network (WAN) (e.g., the Internet 140) and a mobile operator core network 150 via a DSL router, a cable modem, a broadband over power line connection, a satellite Internet connection, or the like.

To implement wireless services via FAPs 110, an owner of the FAPs 110 subscribes to mobile service offered through the mobile operator core network 150. Also, the UE 40 can be capable to operate in a macro cellular environment and/or in a residential small scale network environment, utilizing various techniques described herein. Thus, at least in some disclosed aspects, FAP 110 can be backward compatible with any suitable existing UE 40. Furthermore, in addition to the macro cell mobile network 155, UE 40 is served by a predetermined number of FAPs 110, specifically FAPs 110 that reside within a corresponding user residence(s), place(s) of business, or indoor/outdoor facilities 130, and cannot be in a soft handover state with the macro cell mobile network 155 of the mobile operator core network 150. It should be appreciated that although aspects described herein employ 3GPP terminology, it is to be understood that the aspects can also be applied to various technologies, including 3GPP technology (Release 99 [Rel99], Rel5, Rel6, Rel7), 3GPP2 technology (1xRTT, 1xEV-DO Rel0, RevA, RevB), and other known and related technologies.

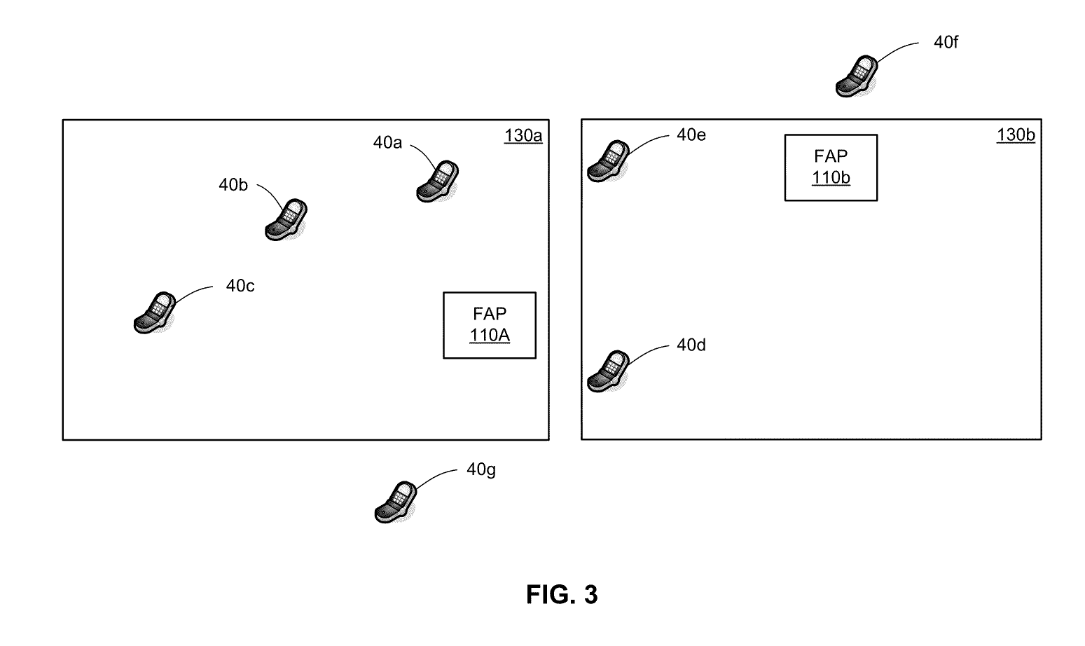

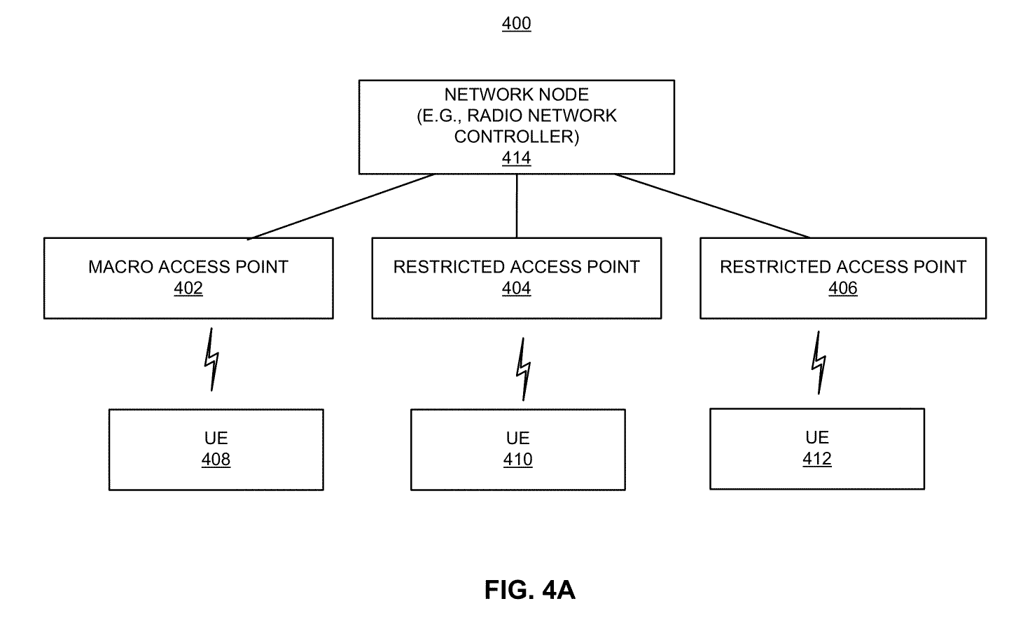

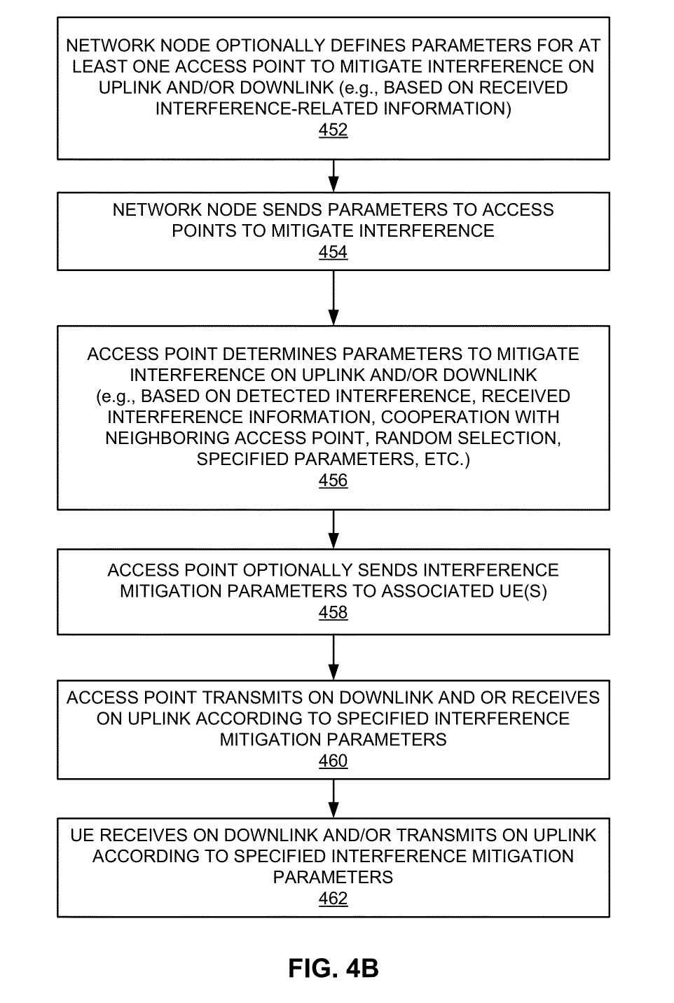

While FIG. 2 illustrates a planned or semi-planned wireless communication environment 100 generally, FIG. 3 illustrates potentially negative geometries of multiple FAPs and UEs within a network environment. As shown in the example of FIG. 4, FAP 110a and FAP 110b are respectively deployed in neighboring user residence 130a and user residence 130b. UEs 40a-40c are permitted to associate and communicate with FAP 110a, but not with FAP 110b. Likewise, UE 40d and UE 40e are permitted to associate and communicate with FAP 110b, but not with FAP 110a. UE 40f and UE 40g are not permitted to associate or communicate with either FAP 110a or FAP 110b. UE 40f and UE 40g may be associated with a macro cell access node 155 (see FIG. 2), or another FAP in another residence (not shown).

In unplanned FAP 110 deployments with restricted associations (i.e., an access point may not be allowed to associate with the “closest” FAP providing the most favorable signal quality), jamming and negative geometries can be common. Solutions to address these negative geometries will be further discussed below.

Referring again to FIGS. 2-3, the owner of a FAP 110 may subscribe to mobile service, such as, for example, 3G mobile service, offered through the mobile operator core network 150. In addition, a UE 40 may be capable of operating both in macro environments and in smaller scale (e.g., residential) network environments. In other words, depending on the current location of the UE 40, the UE 40 may be served by an access node 155 of the macro cell mobile network 150 or by any one of a set of FAPs 110 (e.g., the FAPs 110a and 110b that reside within a corresponding user residence 130). For example, when a subscriber is outside his home, he is served by a standard macro access node (e.g., node 155) and when the subscriber is at home, he is served by a FAP (e.g., FAP 110A). Here, it should be appreciated that a FAP 110 may be backward compatible with existing UEs 40.

A FAP 110 may be deployed on a single frequency or, in the alternative, on multiple frequencies. Depending on the particular configuration, the single frequency or one or more of the multiple frequencies may overlap with one or more frequencies used by a macro node (e.g., node 155).

In some aspects, an UE 40 may be configured to connect to a preferred FAP (e.g., the home FAP of the associated UE 40) whenever such connectivity is possible. For example, whenever the UE 40 is within the user's residence 130, it may be desired that the UE 40 communicate only with the home FAP 110.

In some aspects, if the UE 40 operates within the macro cellular network 150 but is not residing on its most preferred network (e.g., as defined in a preferred roaming list), the UE 40 may continue to search for the most preferred network (e.g., the home FAP 110) using a Better System Reselection (“BSR”), which may involve a periodic scanning of available systems to determine whether better systems are currently available, and subsequent efforts to associate with such preferred systems. With the acquisition entry, the UE 40 may limit the search for specific band and channel. For example, the search for the most preferred system may be repeated periodically. Upon discovery of a preferred FAP 110, the UE 40 selects the FAP 110 for camping within its coverage area.

A FAP may be restricted in some aspects. For example, a given FAP may only provide certain services to certain UEs. In deployments with so-called restricted (or closed) association, a given UE may only be served by the macro cell mobile network and a defined set of FAPs (e.g., the FAPs 110 that reside within the corresponding user residence 130). In some implementations, a node may be restricted to not provide, for at least one node, at least one of: signaling, data access, registration, paging, or service.

In some aspects, a restricted or foreign (alien) FAP (which may also be referred to as a Closed Subscriber Group Home NodeB) is one that provides service to a restricted provisioned set of UEs. This set may be temporarily or permanently extended as necessary. In some aspects, a Closed Subscriber Group (“CSG”) may be defined as the set of access nodes (e.g., FAPs) that share a common access control list of UEs. A channel on which all FAPs (or all restricted FAPs) in a region operate may be referred to as a femto channel.

As stated, in unplanned base station deployments with restricted association (i.e., a UE is not allowed to associate with the “closest” base station to which it has the strongest link), jamming and negative geometries can be common. In one exemplary embodiment spatially described in conjunction with FIG. 3, the FAP 110a and FAP 110b are deployed in neighboring residences. UEs 40a-40c are permitted to associate and communicate with FAP 110a, but not with FAP 110B. Likewise, UEs 40d-40e are permitted to associate and communicate with FAP 110b, but not with FAP 110a. UEs 40f-40g are not permitted to associate or communicate with either FAPs 110a-110b. UEs 40f-40g may be associated with a macro cell access node 155 (FIG. 2), or another FAP in another residence (not shown). Accordingly, such negative geometries regarding access-permitted FAPs and neighboring UEs may result if various interfering or jamming conditions on the UL and DL.

UL Jamming: By way of example, let L_{A3} (dB) and L_{A5} (dB) be the path loss (PL) between FAP (or femto node) 110a and UE 40c and UE 40d, respectively. In particular, L_{A3} may be much larger than L_{A5}. Thus, when UE 40d transmits to its home FAP 110b, it causes excessive interference (or jamming) at FAP 110a, effectively blocking the reception of UEs 40a-c at FAP 110a. In this UL jamming situation, even if UE 40c transmits at its maximum transmit (Tx) power P₃ₘₐₓ, the received C/I for UE at FAP 110a may be characterized as:

C/I(UE 40c at FAP 110a)=P₃ₘₐₓ−L_{A3}−(P₅−L_{A5}) (dB)

In some exemplary embodiments, depending on the transmit power P₅, the C/I of UE 40c at FAP 110a may be a very large negative value due to the large value of L_{A3}. Such a configuration geometry is referred to as a highly negative UL geometry.

DL Jamming: Similarly, in one exemplary embodiment, L_{B5} may be much larger than L_{A5}. This implies that when FAP 110a transmits to UE 40a, it may cause excessive interference (or jamming) at UE 40d, effectively blocking the reception of FAP 110b at UE 40d. In this DL jamming situation, the received C/I for FAP 110b at UE 40d may be calculated as follows:

C/I(FAP 110b at UE 40d)=P_{B}−L_{B5}−(P_{A}−L_{A5}) (dB)

Again, the C/I of FAP 110b at UE 40d may be a very large negative value due to the large value of L_{B5}. Such a configuration geometry is referred to as a highly negative DL geometry.

A further practical consideration includes addressing negative geometries without necessitating modifications to the operation of deployed (legacy) UEs. Therefore, it is desirable in the present exemplary embodiment to address interference mitigation from negative geometries through modification processes in a FAP rather than requiring modifications to UEs. Accordingly, negative geometries at the UL and DL are desirably addressed according to an exemplary embodiment disclosed below.

FIG. 4A illustrates sample aspects of a communication system 400 where distributed nodes (e.g., access points 402, 404, and 406) provide wireless connectivity for other nodes (e.g., UEs 408, 410, and 412) that may be installed in or that may roam throughout an associated geographical area. In some aspects, the access points 402, 404, and 406 may communicate with one or more network nodes (e.g., a centralized network controller such as network node 414) to facilitate WAN connectivity.

An access point, such as access point 404, may be restricted whereby only certain mobile entities (e.g., UE 410) are allowed to access the access point, or the access point may be restricted in some other manner. In such a case, a restricted access point and/or its associated mobile entities (e.g., UE 410) may interfere with other nodes in the system 400 such as, for example, an unrestricted access point (e.g., macro access point 402), its associated mobile entities (e.g., UE 408), another restricted access point (e.g., access point 406), or its associated mobile entities (e.g., UE 412). For example, the closest access point to a given UE may not be the serving access point for the given UE. Consequently, transmissions by the given UE may interfere with reception at another UE that is being served by the access point that is closed to the given UE. Frequency reuse, frequency selective transmission, interference cancellation and smart antenna (e.g., beamforming and null steering) and other techniques may be employed to mitigate interference.

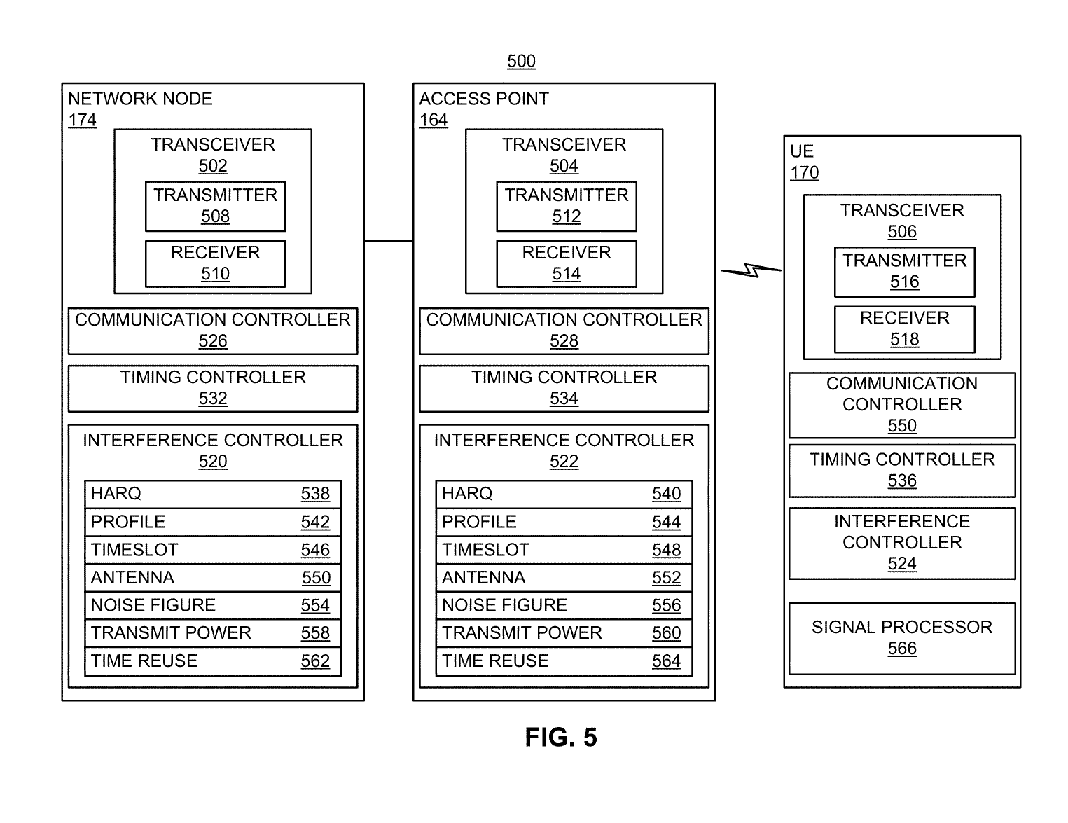

Sample operations of a system such as the system 400 will be discussed in more detail in conjunction with the flowchart of FIG. 4B. For convenience, the operations of FIG. 4B (or any other operations discussed or taught herein) may be described as being performed by specific components (e.g., components of the system 400 and/or components of a system 500 as shown in FIG. 5). It should be appreciated, however, that these operations may be performed by other types of components and may be performed using a different number of components. It also should be appreciated that one or more of the operations described herein may not be employed in a given implementation. For illustration purposes various aspects of the disclosure will be described in the context of a network node, an access point, and an UE that communicate with one another. It should be appreciated, however, that the teachings herein may be applicable to other types of apparatuses or apparatuses that are referred to using other terminology.

FIG. 5 illustrates several sample components that may be incorporated into the network node 414 (e.g., a radio network controller), the access point 404, and the UE 410 in accordance with the teachings herein. It should be appreciated that the components illustrated for a given one of these nodes also may be incorporated into other nodes in the system 400.

The network node 414, the access point 404, and the UE 176 include transceivers 502, 504, and 506, respectively, for communicating with each other and with other nodes. The transceiver 502 includes a transmitter 508 for sending signals and a receiver 510 for receiving signals. The transceiver 504 includes a transmitter 512 for transmitting signals and a receiver 514 for receiving signals. The transceiver 506 includes a transmitter 516 for transmitting signals and a receiver 518 for receiving signals.

In a typical implementation, the access point 404 communicates with the UE 410 via one or more wireless communication links and the access point 404 communicates with the network node 414 via a backhaul. It should be appreciated that wireless or non-wireless links may be employed between these nodes or other in various implementations. Hence, the transceivers 502, 504, and 506 may include wireless and/or non-wireless communication components.

The network node 414, the access point 404, and the UE 410 also include various other components that may be used in conjunction with interference management as taught herein. For example, the network node 414, the access point 404, and the UE 410 may include interference controllers 520, 522, and 524, respectively, for mitigating interference and for providing other related functionality as taught herein. The interference controller 520, 522, and 524 may include one or more components for performing specific types of interference management. The network node 414, the access point 404, and the UE 410 may include communication controllers 526, 528, and 550, respectively, for managing communications with other nodes and for providing other related functionality as taught herein. The network node 414, the access point 404, and the UE 410 may include timing controllers 532, 534, and 536, respectively, for managing communications with other nodes and for providing other related functionality as taught herein. The other components illustrated in FIG. 5 will be discussed in the disclosure that follows.

For illustrative purposes, the interference controllers 520 and 522 are depicted as including several controller components. In practice, however, a given implementation may not employ all of these components. Here, a hybrid automatic repeat request (HARQ) controller component 538 or 540 may provide functionality relating to HARQ interlace operations as taught herein. A profile controller component 542 or 544 may provide functionality relating to transmit power profile or receive attenuation operations as taught herein. A timeslot controller component 546 or 548 may provide functionality relating to timeslot portion operations as taught herein. An antenna controller component 550 or 552 may provide functionality relating to smart antenna (e.g., beamforming and/or null steering) operations as taught herein. A receive noise controller component 554 or 556 may provide functionality relating to adaptive noise figure and PL adjustment operations as taught herein. A transmit power controller component 558 or 560 may provide functionality relating to transmit power operations as taught herein. A time reuse controller component 562 or 564 may provide functionality relating to time reuse operations as taught herein.

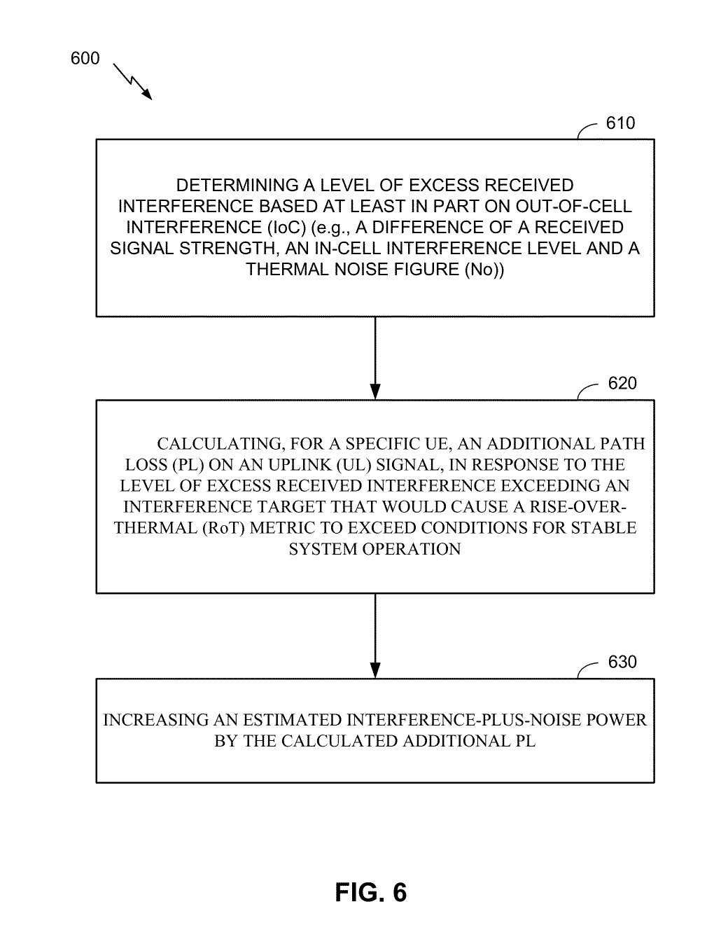

FIG. 4A illustrates how the network node 414, the access point 404, and the UE 410 may interact with one another to provide interference management (e.g., interference mitigation). In some aspects, these operations may be employed on an UL and/or on a DL to mitigate interference. In general, one or more the techniques described by FIG. 4B may be employed in the more specific implementations that are described in conjunction with FIGS. 6-7 and 9 below. Hence, for purposes of clarity, the descriptions of the more specific implementations may not describe these techniques again in detail.

As represented by block 452, the network node 414 (e.g., the interference controller 520) may optionally define one or more interference management parameters for the access point 404 and/or the UE 410. Such parameters may take various forms. For example, in some implementations the network node 414 may define types of interference management information. Examples of such parameters will be described in more detail below in conjunction with FIGS. 6-7 and 9.

In related aspects, the network node 414 may define a parameter based on received information that indicates whether there may be interference on an UL or a DL and, if so, the extent of such interference. Such information may be received from various nodes in the system (e.g., access points and/or UEs) and in various ways (e.g., over a backhaul, over-the-air, and so on).

For example, in some cases one or more access points (e.g., the access point 404) may monitor an UL and/or a DL and send an indication of interference detected on the UL and/or DL to the network node 414 (e.g., on a repeated basis or upon request). As an example of the former case, the access point 404 may calculate the signals strength of signals it receives from nearby UEs that are not associated with (e.g., served by) the access point 404 (e.g., UEs 408 and 412) and report this to the network node 414.

In some cases, each of the access points in the system may generate a load indication when they are experiencing relatively high loading. Such an indication may take the form of, for example, a busy bit in 1xEV-DO, a relative grant channel (“RGCH”) in 3GPP, or some other suitable form. In a conventional scenario, an access point may send this information to its associated UE via a DL. However, such information also may be sent to the network node 414 (e.g., via the backhaul).

In some cases, one or more UEs (e.g., the UE 410) may monitor DL signals and provide information based on this monitoring. The UE 410 may send such information to the access point 404 (e.g., which may forward the information to the network node 414) or to the network node 414 (via the access point 404). Other UEs in the system may send information to the network node 414 in a similar manner.

In some cases, the UE 410 may generate measurement reports (e.g., on repeated basis). In some aspects, such a measurement report may indicate which access points the UE 410 is receiving signals from, a received signal strength indication associated with the signals from each access point (e.g., Ec/Io), the PL to each of the access points, or some other suitable type of information. In some cases a measurement report may include information relating to any load indications the UE 410 received via a DL.

The network node 414 may then use the information from one or more measurement reports to determine whether the access point 404 and/or the UE 410 are relatively close to another node (e.g., another access point or UE). In addition, the network node 414 may use this information to determine whether any of these nodes interfere with any other one of these nodes. For example, the network node 414 may determine received signal strength at a node based on the transmit power of a node that transmitted the signals and the PL between these nodes.

In some cases, the UE 410 may generate information that is indicative of the signal to noise ratio (e.g., signal and interference to noise ratio, SINR) on a DL. Such information may comprise, for example a channel quality indication (“CQI”), a data rate control (“DRC”) indication, or some other suitable information. In some cases, this information may be sent to the access point 404 and the access point 404 may forward this information to the network node 414 for use in interference management operations. In some aspects, the network node 414 may use such information to determine whether there is interference on a DL or to determine whether interference in the DL is increasing or decreasing.

As will be described in more detail below, in some cases the interference-related information may be used to determine how to mitigate interference. As one example, CQI or other suitable information may be received on a per-HARQ interlace basis whereby it may be determined which HARQ interlaces are associated with the lowest level of interference. A similar technique may be employed for other fractional reuse techniques.

It should be appreciated that the network node 414 may define parameters in various other ways. For example, in some cases the network node 414 may randomly select one or more parameters.

As represented by block 454, the network node 414 (e.g., the communication controller 526) sends the defined interference management parameters to the access point 404. As will be discussed below, in some cases the access point 404 uses these parameters and in some cases the access point 404 forwards these parameters to the UE 410.

In some cases, the network node 414 may manage interference in the system by defining the interference management parameters to be used by two or more nodes (e.g., access points and/or UEs) in the system. For example, in the case of a fractional reuse scheme, the network node 414 may send different (e.g., mutually exclusive) interference management parameters to neighboring access points (e.g., access points that are close enough to potentially interfere with one another). As a specific example, the network node 414 may assign a first HARQ interlace to the access point 404 and assign a second HARQ interlace to the access point 406. In this way, communication at one restricted access point may not substantially interfere with communication at the other restricted access point.

As represented by block 456, the access point 404 (e.g., the interference controller 522) determines interference management parameters that it may use or that may send to the UE 410. In cases where the network node 414 defines the interference management parameters for the access point 404, this determination operation may simply involve receiving the specified parameters and/or retrieving the specified parameters (e.g., from a data memory).

In some cases the access point 404 determines the interference management parameters on its own. These parameters may be similar to the parameters discussed above in conjunction with block 452. In addition, in some cases these parameters may be determined in a similar manner as discussed above at block 452. For example, the access point 404 may receive information (e.g., measurement reports, CQI, DRC) from the UE 410. In addition, the access point 404 may monitor an UL and/or a DL to determine the interference on such a link. The access point 404 also may randomly select a parameter.

In some cases, the access point 404 may cooperate with one or more other access points to determine an interference management parameter. For example, in some cases the access point 404 may communicate with the access point 406 to determine which parameters are being used by the access point 406 (and thereby selects different parameters) or to negotiate the use of different (e.g., mutually exclusive) parameters. In some cases, the access point 404 may determine whether it may interfere with another node (e.g., based on CQI feedback that indicates that another node is using a resource) and, if so, define its interference management parameters to mitigate such potential interference.

As represented by block 458, the access point 404 (e.g., the communication controller 528) may send interference management parameters or other related information to the UE 410. In some cases this information may relate to power control (e.g., specifies UL transmit power).

As represented by blocks 460 and 462, the access point 404 may thus transmit to the UE 410 on the DL or the UE 410 may transmit to the access point 404 on the UL. Here, the access point 404 may use its interference management parameters to transmit on the DL and/or receive on the UL. Similarly, the UE 410 may take these interference management parameters into account when receiving on the DL or transmitting on the UL.

In some implementations the UE 410 (e.g., the interference controller 506) may define one or more interference management parameters. Such a parameter may be used by the UE 410 and/or sent (e.g., by the communication controller 530) to the access point 404 (e.g., for use during UL operations).

In accordance with aspects of the embodiments described herein, there are provided techniques for reducing the UL interference at a FAP. Specifically, Adaptive UL Attenuation (AUA) algorithm has been proposed to apply additional attenuation to the total received signal at the femtocell in presence of various types of interference, including the out-of-cell interference due to the nearby jammer as well as the in-cell interference due to the small PL between the mobile and its serving femtocell. However, AUA has the following issues that can be potentially improved.

If AUA is triggered, the additional attenuation will be applied to all in-cell mobiles. But in some cases, it would be preferable to attenuate only a subset of mobiles. Two use cases of this user-specific attenuation are described below. In related aspects, if a served mobile is too close to the femtocell, it would be preferable to only attenuate that mobile, so that the Tx power of other mobiles will not increase as much as that increased by attenuating all served mobiles. The less mobile Tx power increase will reduce the UL interference to the neighboring cells.

In further related aspects, another application is to solve the High Speed Dedicated Physical Control Channel (HS-DPCCH) decoding failure issue for a high-speed DL packet access (HSDPA) mobile in UL Soft Hand Over (SHO) with multiple femtocells. Among all SHO cells, the cell providing HSDPA service to the mobile in DL may not be the closest one to the mobile due to its stronger DL pilot Tx power. In this case, a closer SHO cell may keep the mobile Tx power sufficiently low to just satisfy the required signal to noise (SNR) at that cell. However, the low Tx power may be insufficient to decode the mobile's feedback info on UL HS-DPCCH at the farther HSDPA-serving cell due to the larger PL. To make it decodable, a fixed attenuation can be applied only to this mobile's received signal at the closer SHO cell, which will therefore raise the mobile Tx power to compensate the degraded SNR. As a result, the increased Tx power will make the HS-DPCCH decoding successful at the HSDPA-serving cell. In this case, unlike AUA attenuating all users, the user-specific attenuation is preferable in the sense that only the HSDPA mobiles in SHO will be attenuated to reduce the adverse impact on the other mobiles.

If AUA is triggered, the additional attenuation essentially increases the actual interference-plus-noise power, which boosts the Tx power of all in-cell mobiles to overcome the interference. However, the mobile Tx power can be boosted by methods not increasing the actual interference-plus-noise power and, hence the SNR can be improved over AUA for the same mobile Tx power. Also, AUA requires hardware modification, which can be avoided by equivalent baseband processing methods, as descried herein.

Virtual Adaptive UL Attenuation: In accordance with one or more embodiments of the present disclosure, there is provided a technique for virtual adaptive UL attenuation by modifying an estimated interference-plus-noise power in UL power control.

As noted above, to reduce the UL interference at a femtocell, AUA algorithm has been proposed to apply additional attenuation to the total received signal at the femtocell in presence of interference. However, certain aspects of AUA may be improved.

With respect to a first AUA aspect to be improved, if AUA is triggered, the additional attenuation may be applied to all in-cell UEs. But in some cases, it would be preferable to attenuate only a subset of the UEs. Two use cases of this user-specific attenuation are described herein. In a first user-specific attenuation case, if a served UE is too close to the femtocell, it would be preferable to only attenuate that UE, so that the Tx power of other UEs will not increase as much as that increased by attenuating all served UEs. The reduction in the mobile/UE Tx power increase will reduce the UL interference to the neighboring cells. In a second user-specific attenuation case, another application of AUA is to solve the HS-DPCCH decoding failure issue for a HSDPA UE in UL SHO with multiple femtocells. Among all SHO cells, the cell providing HSDPA service to the UE in DL may not be the closest one to the UE due to its stronger DL pilot Tx power. In this case, a closer SHO cell may keep the UE Tx power sufficiently low to just satisfy the required SNR at that cell. However, the low Tx power may be insufficient to decode the UE's feedback info on UL HS-DPCCH at the farther HSDPA-serving cell due to the larger PL. To make it decodable, a fixed attenuation may be applied only to this UE's received signal at the closer SHO cell, which may raise the UE Tx power to compensate for the degraded SNR. As a result, the increased Tx power will make the HS-DPCCH decoding successful at the HSDPA-serving cell. In this case, unlike AUA attenuating all users, the user-specific attenuation is preferable in the sense that only the HSDPA mobiles in SHO will be attenuated to reduce the adverse impact on the other UEs.

With respect to a second AUA aspect to be improved, if AUA is triggered, the additional attenuation essentially increases the actual interference-plus-noise power, which boosts the Tx power of all in-cell UEs to overcome the interference. However, the UE Tx power can be boosted by methods that do not increase the actual interference-plus-noise power, and hence the SNR can be improved over AUA for the same UE Tx power. With respect to a third AUA aspect to be improved, AUA may involve hardware modification, which can be avoided by equivalent the baseband processing methods described herein.

In accordance with one or more embodiments of the embodiments described herein, a Virtual Adaptive UL Attenuation (VAUA) technique is provided to address and improve upon the three AUA aspects described above. The functions of AUA may be achieved by VAUA via modifying the estimated interference-plus-noise power in the UL power control algorithm. In addition, the VAUA may realize the user-specific attenuation, since the modification can be done for any subset of users. Compared with AUA, the user-specific nature of VAUA can reduce both UL inter-femto and femto-to-macro interference especially in enterprise scenario, where both types of interference are more pronounced due to the denser femto deployment. The VAUA can also improve the UL SNR, since no actual noise injection or signal attenuation is induced. For example, to handle bursty interference, each user's UL signal may be attenuated by AUA even in the absence of bursty interference due to the delay of attenuation decrease, while VAUA does not add actual noise or attenuation and hence can achieve higher SNR in this case. Finally, the modification is based on baseband processing and hence does not require hardware modifications. The VAUA technique may be generally applied to various wireless systems, including, but not limited to, WCDMA/High Speed Packet Access (HSPA) (UMTS), 1xDO, etc.

For UL power control, the serving cell may adjust the UE Tx power so that the received pilot chip energy to interference ratio (Ecp/Nt) at the serving cell can be maintained at a target. The Ecp/Nt is usually computed as the ratio of estimated Ecp to estimated Nt. The VAUA is based on modifying the estimated Nt as below:

Ñt(n)=\hat{N}t(n)+V(n)

V(n)=([No(n)]_{dBm}+[Pad(n)]_{dB})−No(n) (1)

wherein n denotes the slot index, Nt(n) represent the originally estimated Nt, No(n) represents the thermal noise power, and the applied pad (equivalent to interference-plus-noise power increase for that user) can be computed similar to that in AUA as:

[Pad(n)]_{dB}=max([Pad₁(n)]_{dB},[Pad₂(n)]_{dB},[Pad₃(n)]_{dB},[Pad₄(n)]_{dB},0) (2)

wherein each pad component is computed based on the user-specific inputs and hence can vary for different users. This is different from AUA, which computes each pad component in the same way for all served users. The user-specific padding allows VAUA to apply padding only to the users in need, such as those too close to the serving femtocell or those suffering the HS-DPCCH decoding failure issue described above. The computation of each component is described below and can have different variations as well.

The first component in equation (2) is to control the out-of-cell interference and can be computed as:

$${[ {Pad}_{1} ( n ) ]}_{dB} = {[ ( \frac{\hat{I} oc}{No} ) ( n ) ]}_{dB} - {[ {( \frac{Ioc}{No} )}_{target} ( n ) ]}_{dB} \\ where ( \frac{\hat{I} oc}{No} ) ( n ) \qquad ( 3 )$$

is the estimated out-of-cell interference to noise ratio and

$${( \frac{Ioc}{No} )}_{target} ( n )$$

represents the corresponding target. This component is to make the post-padding out-of-cell interference to be equal to the target.

The second component in equation (2) is to control the actual Ecp/Nt when the user is too close to the serving femtocell and can be specified as:

$${[ {Pad}_{2} ( n ) ]}_{dB} = {[ ( \frac{\hat{E} cp}{\hat{N} t} ) ( n ) ]}_{dB} - {[ {( \frac{Ecp}{Nt} )}_{target} ( n ) ]}_{dB} \\ where ( \frac{\hat{E} cp}{\hat{N} t} ) ( n ) \qquad ( 4 )$$

is the actual estimated Ecp/Nt and

$${( \frac{Ecp}{Nt} )}_{target} ( n )$$

represents the corresponding target. This component is to make the post-padding Ecp/Nt to be equal to the target.

The third component in equation (2) is to delay the decrease of pad to handle the bursty interference and can be:

[Pad₃(n)]_{dB}=[Pad₃(n−1)]_{dB}−[Pad_step_down]_{dB} (5)

wherein Pad_step_down determines the pad decrease step size. This component is to make the pad decrease not too fast to reserve certain margin for the coming interference burst.

The last component in equation (2) is to solve for the HS-DPCCH decoding failure issue by adding a fixed pad at the nearby non-HSDPA-serving cell to raise the UE Tx power for successful HS-DPCCH UL feedback channel decoding at the farther HSDPA serving cell, wherein:

$${[ {Pad}_{4} ( n ) ]}_{dB} = \{ \begin{matrix}max ( 0 , \begin{matrix}{[ HSDPA\_serving \_cell \_Txpwr ]}_{dB} - \\ {[ HSDPA\_non \_serving \_cell \_Txpwr ]}_{dB}\end{matrix} ) , & \begin{matrix}if this user is HSDPA \\ user in uplink SHO\end{matrix} \\ 0 , & otherwise\end{matrix} \qquad ( 6 )$$

wherein HSDPA_serving_cell_Txpwr is the HSDPA serving cell Tx power and HSDPA_non_serving_cell_Txpwr represents the Tx power of the HSDPA non-serving cell. This component will be active when the considered user has HSDPA service in DL with the HSDPA serving cell and is in SHO in UL with both serving and non-serving cells. If the HSDPA serving cell has higher Tx power than that of the non-serving cell, a pad equal to the Tx power difference may be applied to that user at the non-serving cell, so that the user transmit power can be increased accordingly to make the UL feedback channel decodable at the farther HSDPA serving cell.

As an independent application, additional PL may be added at the UE side when it is close to the serving cell. In such as case, the UE may not be able to reduce its transmit power due to it hitting the minimum output power. Thus, the noise rise at the serving cell may be too high due to the irreducible UE transmit power and its small PL. The high noise rise may affect the UL access for far away users and also the user data rate if the noise rise threshold is exceeded.

Specifically, the serving cell or a radio network controller (RNC) may first compute the additional PL as:

[Pad₅(n)]_{dB}=max([Êc(n)]_{dB}−[Ec_{target}(n)]_{dB},0) (7)

wherein Êc(n) is the estimated mobile received power at the serving cell and Ec_{target}(n) represents the corresponding target. Next, the computing entity will send the computed [Pad₅(n)] to the mobile, which will apply this amount of attenuation at the mobile amplifier output, so that the final emitted power and hence the received power are reduced by this amount.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

In accordance with one or more aspects of the embodiments described herein, with reference to FIG. 6, there is shown a VAUA methodology 600, operable by a network entity (e.g., an eNB). Specifically, method 600 describes a way to reduce UL interference by modifying the estimated interference-plus-noise power in UL power control. The method 600 may involve, at 610, determining a level of excess received interference based at least in part on out-of-cell interference (Ioc) (e.g., a difference of a received signal strength, an in-cell interference level and a thermal noise figure (No)). The method 800 may involve, at 620, calculating, for a specific UE, an additional PL on an UL signal, in response to the level of excess received interference exceeding an interference target that would cause a Rise-over-Thermal (RoT) metric to exceed conditions for stable system operation. The method 800 may involve, at 630, increasing an estimated interference-plus-noise power by the calculated additional PL.

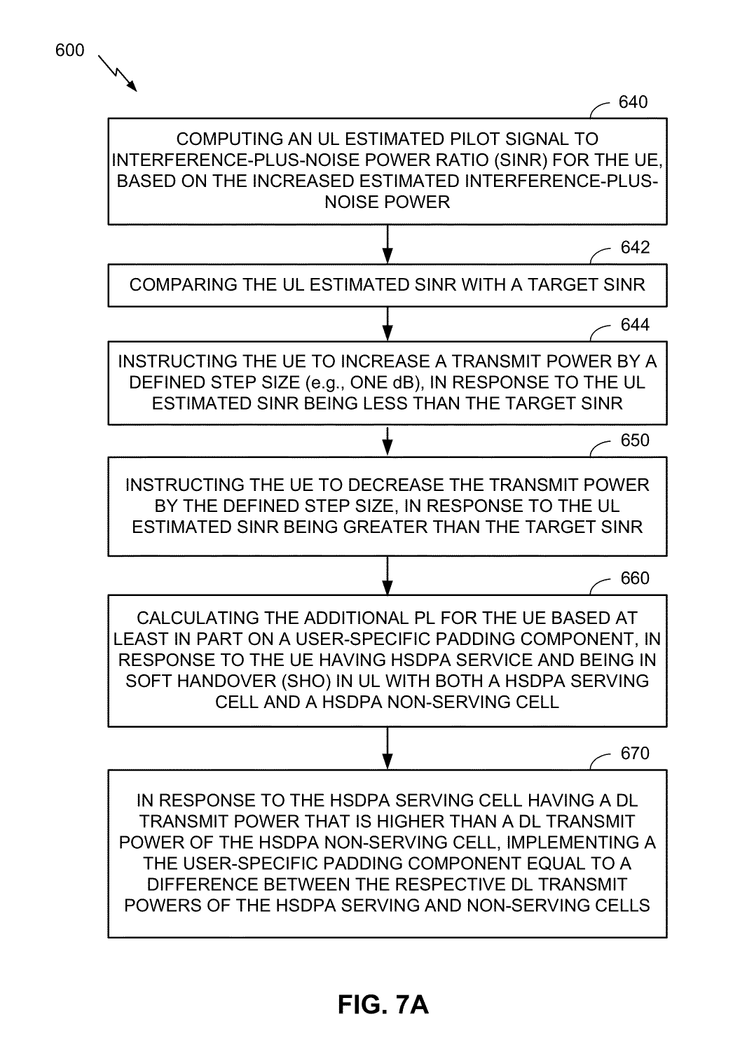

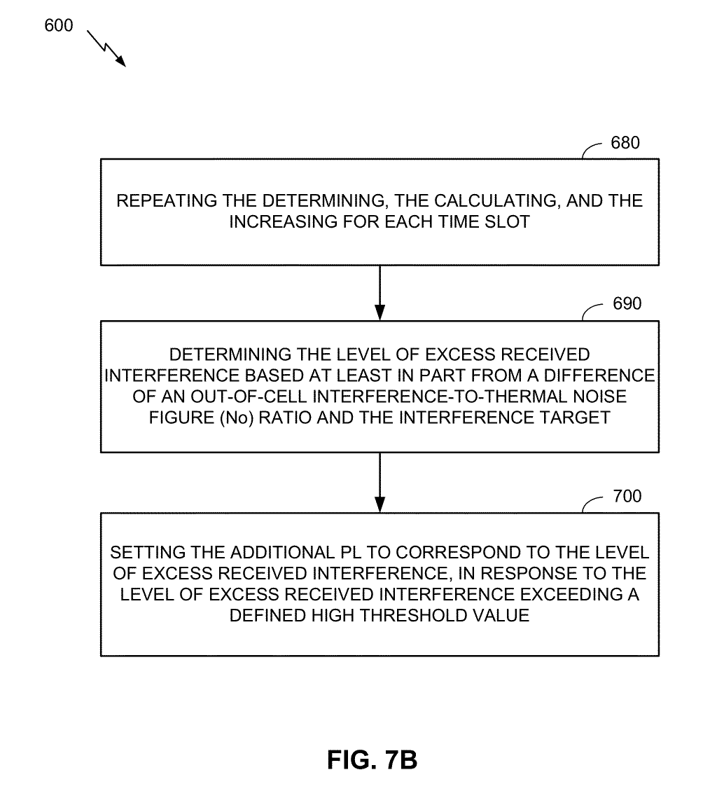

With reference to FIGS. 7A-B, there are shown further operations or aspects of the method 600 that are optional and may be performed by a network entity or the like. If the method 600 includes at least one block of FIG. 6, then the method 600 may terminate after the at least one block, without necessarily having to include any subsequent downstream block(s) that may be illustrated. It is further noted that numbers of the blocks do not imply a particular order in which the blocks may be performed according to the method 600. For example, the method 600 may further involve: computing an UL estimated pilot signal to interference-plus-noise power ratio (SINR) for the UE, based on the increased estimated interference-plus-noise power (block 640); comparing the UL estimated SINR with a target SINR (block 642); and instructing the UE to increase a transmit power by a defined step size (e.g., one dB), in response to the UL estimated SINR being less than the target SINR (block 644). The method 600 may involve instructing the UE to decrease the transmit power by the defined step size, in response to the UL estimated SINR being greater than the target SINR (block 650).

In related aspects, calculating (block 620) may involve calculating the additional PL for the UE based at least in part on a user-specific padding component, in response to the UE having HSDPA service and being in soft handover (SHO) in UL with both a HSDPA serving cell and a HSDPA non-serving cell (block 660). Calculating (block 660) may involve, in response to the HSDPA serving cell having a DL transmit power that is higher than a DL transmit power of the HSDPA non-serving cell, implementing a the user-specific padding component equal to a difference between the respective DL transmit powers of the HSDPA serving and non-serving cells (block 670).

In further related aspects, the network entity may be a small base station, an eNB, or the like. The small base station may be a femtocell, a picocell, or the like. In the alternative, the network entity may be an RNC or the like.

In yet further related aspects, the method 600 may involve repeating the determining, the calculating, and the increasing for each time slot (block 680). The method 600 may involve determining the level of excess received interference based at least in part from a difference of an out-of-cell interference-to-thermal noise figure (No) ratio and the interference target (block 690). The method 600 may involve setting the additional PL to correspond to the level of excess received interference, in response to the level of excess received interference exceeding a defined high threshold value (block 700).

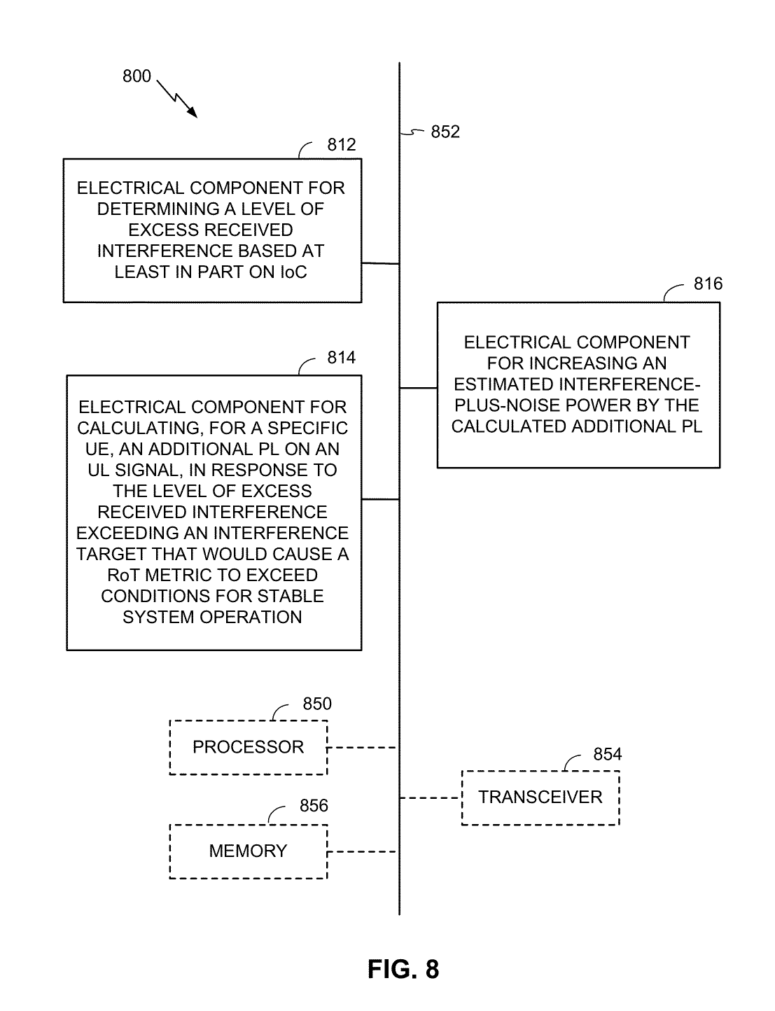

In accordance with one or more aspects of the embodiments described herein, there are provided devices and apparatuses for power control, as described above with reference to FIGS. 6-7. With reference to FIG. 8, there is provided an exemplary apparatus 800 that may be configured as a network entity (e.g., eNB) in a wireless network, or as a processor or similar device/component for use within the network entity. The apparatus 800 may include functional blocks that can represent functions implemented by a processor, software, or combination thereof (e.g., firmware). For example, apparatus 800 may include an electrical component or module 812 for determining a level of excess received interference based at least in part on Ioc. The apparatus 800 may also include a component 814 for calculating, for a specific UE, an additional PL on an UL signal, in response to the level of excess received interference exceeding an interference target that would cause a RoT metric to exceed conditions for stable system operation. The apparatus 800 may also include a component 816 for increasing an estimated interference-plus-noise power by the calculated additional PL.

In related aspects, the apparatus 800 may optionally include a processor component 850 having at least one processor, in the case of the apparatus 800 configured as a network entity (e.g., an eNB), rather than as a processor. The processor 850, in such case, may be in operative communication with the components 812-816 via a bus 852 or similar communication coupling. The processor 850 may effect initiation and scheduling of the processes or functions performed by electrical components 812-816.

In further related aspects, the apparatus 800 may include a radio transceiver component 854. A stand alone receiver and/or stand alone transmitter may be used in lieu of or in conjunction with the transceiver 854. When the apparatus 800 is an AP or similar network entity, the apparatus 800 may also include a network interface (not shown) for connecting to one or more core network entities. The apparatus 800 may optionally include a component for storing information, such as, for example, a memory device/component 856. The computer readable medium or the memory component 856 may be operatively coupled to the other components of the apparatus 800 via the bus 852 or the like. The memory component 856 may be adapted to store computer readable instructions and data for effecting the processes and behavior of the components 812-816, and subcomponents thereof, or the processor 850, or the methods disclosed herein. The memory component 856 may retain instructions for executing functions associated with the components 812-816. While shown as being external to the memory 856, it is to be understood that the components 812-816 can exist within the memory 856. It is further noted that the components in FIG. 8 may comprise processors, electronic devices, hardware devices, electronic sub-components, logical circuits, memories, software codes, firmware codes, etc., or any combination thereof.

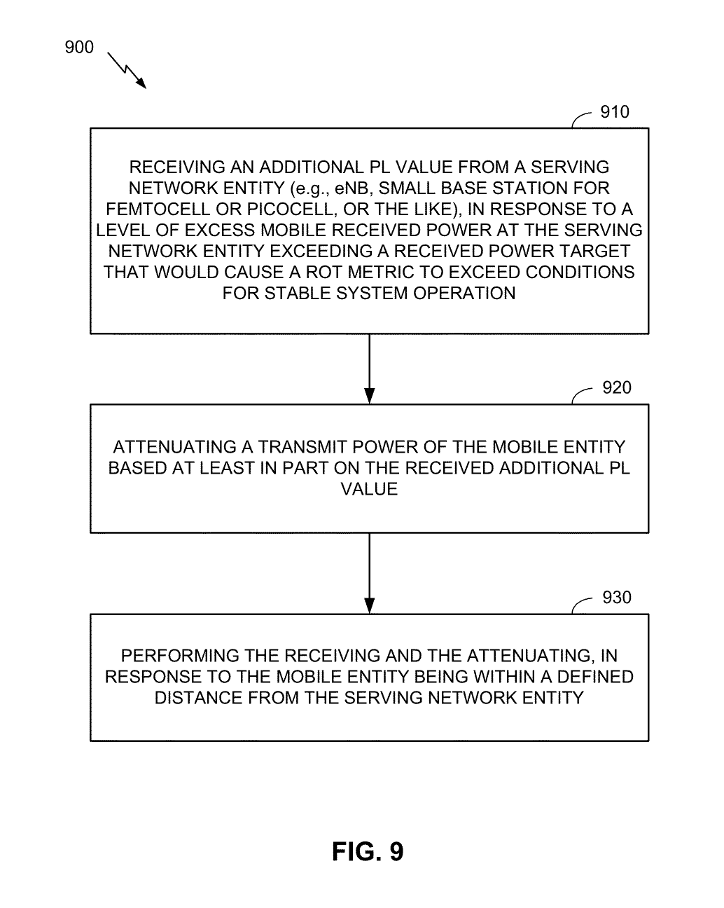

In accordance with one or more aspects of the embodiments described herein, with reference to FIG. 9, there is shown a VAUA methodology 900, operable by a mobile entity (e.g., a UE) to facilitate the reduction of UL interference. The method 900 may involve, at 910, receiving an additional PL value from a serving network entity (e.g., eNB, small base station for femtocell or picocell, or the like), in response to a level of excess mobile received power at the serving network entity exceeding a received power target that would cause a RoT metric to exceed conditions for stable system operation. The method 900 may involve, at 920, attenuating a transmit power of the mobile entity based at least in part on the received additional PL value. In related aspects, the method 900 may optionally involve, at 930, performing the receiving and the attenuating, in response to the mobile entity being within a defined distance from the serving network entity.

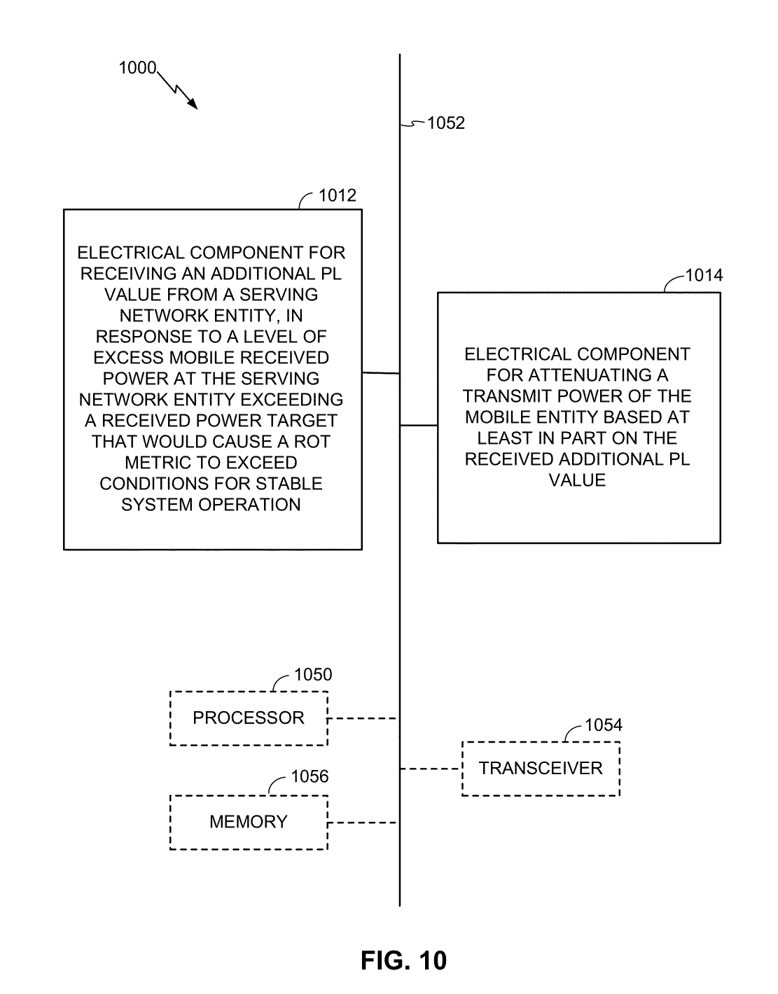

In accordance with one or more aspects of the embodiments described herein, FIG. 10 shows a design of an apparatus 1000 (e.g., a mobile entity or component(s) thereof) for VAUA, as described above with reference to the methodology 900 of FIG. 9. For example, apparatus 1000 may include an electrical component or module 1012 for receiving an additional PL value from a serving network entity, in response to a level of excess mobile received power at the serving network entity exceeding a received power target that would cause a RoT metric to exceed conditions for stable system operation. The apparatus 1000 may include a component 1014 for attenuating a transmit power of the mobile entity based at least in part on the received additional PL value.

For the sake of conciseness, the rest of the details regarding apparatus 1000 are not further elaborated on; however, it is to be understood that the remaining features and aspects of the apparatus 1000 are substantially similar to those described above with respect to apparatus 800 of FIG. 8.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method operable by a network entity in a wireless communication system, the method comprising:
determining a level of excess received interference based at least in part on out-of-cell interference (Ioc);
calculating, for a specific user equipment (UE), an additional path loss (PL) on an uplink signal, in response to the level of excess received interference exceeding an interference target that would cause a Rise-over-Thermal (RoT) metric to exceed conditions for stable system operation; and
increasing an estimated interference-plus-noise power by the calculated additional PL.

2. The method of claim 1, further comprising:
computing an uplink estimated pilot signal to interference-plus-noise power ratio (SINR) for the UE, based on the increased estimated interference-plus-noise power;
comparing the uplink estimated SINR with a target SINR; and
instructing the UE to increase a transmit power by a defined step size, in response to the uplink estimated SINR being less than the target SINR.

3. The method of claim 2, further comprising instructing the UE to decrease the transmit power by the defined step size, in response to the uplink estimated SINR being greater than the target SINR.

4. The method of claim 2, wherein the defined step size comprises one dB.

5. The method of claim 1, wherein the calculated additional PL for the UE is based at least in part on a user-specific padding component, in response to the UE having high-speed downlink packet access (HSDPA) service and being in soft handover (SHO) in uplink with both a HSDPA serving cell and a HSDPA non-serving cell.

6. The method of claim 5, wherein, in response to the HSDPA serving cell having a downlink transmit power that is higher than a downlink transmit power of the HSDPA non-serving cell, the user-specific padding component comprises a difference between the respective downlink transmit powers of the HSDPA serving and non-serving cells.

7. The method of claim 1, wherein the network entity comprises one of a small base station and an evolved Node B (eNB).

8. The method of claim 7, wherein the small base station comprises one of a femtocell and a picocell.

9. The method of claim 1, wherein the network entity comprises a radio network controller (RNC).

10. The method of claim 1, further comprising repeating the determining, the calculating, and the increasing for each time slot.

11. The method of claim 1, wherein the Ioc is a difference of a received signal strength, an in-cell interference level and a thermal noise figure (No).

12. The method of claim 1, wherein the level of excess received interference is determined at least in part from a difference of an Ioc-to-No ratio and the interference target.

13. The method of claim 1, wherein the additional PL corresponds to the level of excess received interference, in response to the level of excess received interference exceeding a defined high threshold value.

14. An apparatus, comprising:
at least one processor configured to: (a) determine a level of excess received interference based at least in part on out-of-cell interference (Ioc); (b) calculate, for a specific user equipment (UE), an additional path loss (PL) on an uplink signal, in response to the level of excess received interference exceeding an interference target that would cause a Rise-over-Thermal (RoT) metric to exceed conditions for stable system operation; and (c) increase an estimated interference-plus-noise power by the calculated additional PL; and
a memory coupled to the at least one processor for storing data.

15. The apparatus of claim 14, wherein the at least one processor is further configured to:
compute an uplink estimated pilot signal to interference-plus-noise power ratio (SINR) for the UE, based on the increased estimated interference-plus-noise power;
compare the uplink estimated SINR with a target SINR; and
instruct the UE to increase a transmit power by a defined step size, in response to the uplink estimated SINR being less than the target SINR.

16. The apparatus of claim 14, wherein the calculated additional PL for the UE is based at least in part on a user-specific padding component, in response to the UE having high-speed downlink packet access (HSDPA) service and being in soft handover (SHO) in uplink with both a HSDPA serving cell and HSDPA non-serving cell.

17. The apparatus of claim 16, wherein, in response to the HSDPA serving cell having a downlink transmit power that is higher than a downlink transmit power of the HSDPA non-serving cell, the user-specific padding component comprises a difference between the respective downlink transmit powers of the HSDPA serving and non-serving cells.

18. The apparatus of claim 14, wherein the apparatus comprises one of a small base station and an evolved Node B (eNB).

19. An apparatus, comprising:
means for determining a level of excess received interference based at least in part on out-of-cell interference (Ioc);
means for calculating, for a specific user equipment (UE), an additional path loss (PL) on an uplink signal, in response to the level of excess received interference exceeding an interference target that would cause a Rise-over-Thermal (RoT) metric to exceed conditions for stable system operation; and
means for increasing an estimated interference-plus-noise power by the calculated additional PL.

20. The apparatus of claim 19, wherein the at least one processor is further configured to:
means for computing an uplink estimated pilot signal to interference-plus-noise power ratio (SINR) for the UE, based on the increased estimated interference-plus-noise power;
means for comparing the uplink estimated SINR with a target SINR; and
means for instructing the UE to increase a transmit power by a defined step size, in response to the uplink estimated SINR being less than the target SINR.

21. A computer program product, comprising:
a computer-readable medium comprising code for causing a computer to:
determine a level of excess received interference based at least in part on out-of-cell interference (Ioc);
calculate, for a specific user equipment (UE), an additional path loss (PL) on an uplink signal, in response to the level of excess received interference exceeding an interference target that would cause a Rise-over-Thermal (RoT) metric to exceed conditions for stable system operation; and
increase an estimated interference-plus-noise power by the calculated additional PL.

22. A method operable by a mobile entity in a wireless communication system, the method comprising:
receiving an additional path loss (PL) value from a serving network entity, in response to a level of excess mobile received power at the serving network entity exceeding a received power target that would cause a Rise-over-Thermal (RoT) metric to exceed conditions for stable system operation; and
attenuating a transmit power of the mobile entity based at least in part on the received additional PL value.

23. The method of claim 22, further comprising performing the receiving and the attenuating, in response to the mobile entity being within a defined distance from the serving network entity.

24. The method of claim 22, wherein:
the mobile entity comprises a user equipment (UE); and
the serving network entity comprises one of a small base station and an evolved Node B (eNB).

25. The method of claim 24, wherein the small base station comprises one of a femtocell and a picocell.

26. An apparatus, comprising:
at least one processor configured to: (a) receiving an additional path loss (PL) value from a serving network entity, in response to a level of excess mobile received power at the serving network entity exceeding a received power target that would cause a Rise-over-Thermal (RoT) metric to exceed conditions for stable system operation; and
(b) attenuating a transmit power of the mobile entity based at least in part on the received additional PL value; and
a memory coupled to the at least one processor for storing data.

27. The apparatus of claim 26, wherein the at least one processor is further configured to perform the receiving and the attenuating, in response to the apparatus being within a defined distance from the serving network entity.

28. The method of claim 26, wherein:
the apparatus comprises a user equipment (UE); and
the serving network entity comprises one of a small base station and an evolved Node B (eNB).

29. An apparatus, comprising:
means for receiving an additional path loss (PL) value from a serving network entity, in response to a level of excess mobile received power at the serving network entity exceeding a received power target that would cause a Rise-over-Thermal (RoT) metric to exceed conditions for stable system operation; and
means for attenuating a transmit power of the mobile entity based at least in part on the received additional PL value.

30. The apparatus of claim 29, further comprising means for performing the receiving and the attenuating, in response to the apparatus being within a defined distance from the serving network entity.

31. A computer program product, comprising:
a computer-readable medium comprising code for causing a computer to:
receive an additional path loss (PL) value from a serving network entity, in response to a level of excess mobile received power at the serving network entity exceeding a received power target that would cause a Rise-over-Thermal (RoT) metric to exceed conditions for stable system operation; and
attenuate a transmit power of the mobile entity based at least in part on the received additional PL value.
